(19) United States
(12) Patent Application Publication
(10) Pub. No.: US 2010/0221534 A1
(43) Pub. Date: Sep. 2, 2010

(54) Heat Sensitive, Solvent Sensitive, Tamper Evident, Multipurpose Security Label and the Method of Manufacturing The Same

(76) Inventors: Prafulla Kumar Manna, Maharashtra (IN); Nityananda Shekar Shenoy, Maharashtra (IN); Pradip Hiralal Shroff, Maharashtra (IN)

Correspondence Address: LESTER H. BIRNBAUM, 6 OAKMOUNT COURT, SIMPSONVILLE, SC, 29681, US

(21) Appl. No.: 12/087,032

(22) PCT Filed: Mar. 27, 2006
(86) PCT No.: PCT/IN2006/000126

§ 371 Date: Jun. 23, 2008

(30) Foreign Application Priority Data
Dec. 27, 2005 (IN) 1625/MUM/2005

(51) Int. Cl. C09J 7/02; B32B 38/10; C09J 7/04

(52) U.S. Cl. 428/354; 156/250

(57) ABSTRACT

A method of manufacturing “heat sensitive, solvent sensitive, tamper evident multi purpose security label” comprising coating the formulated compound to constitute a film on a double sided silicone resin coated substrate and thereafter coated with high tack adhesive on double side silicone resin coated substrate and then by laminating the said film is slitted to desired length and size.

### FIELD OF INVENTION

This invention relates to “Heat sensitive, solvent sensitive, tamper evident multi purpose security labels” and the process of manufacturing the same. It is a heat sensitive, solvent sensitive and a tamper evident label designed for manufacturing security labels. There are few variants like the silver/bronze or other sparkling colour of the said labels.

This novel product provides to a manufacturer as well as an end customer with the advantage of ‘seal of guarantee’ for enabling him to protect the value of his brand/product/franchise and prevent the fraudsters and counterfeiters from illegal, unauthorized and unintended use of the product to be protected and to maintain the reputation and goodwill attached to the products/brands.

### DESCRIPTION OF THE PRIOR ART

Traditional technologies for brand protection and authentication utilized solutions like labels and seals made using holograms, low strength security papers which would come off in bits and pieces when attempted to be removed from the substrate. To further complicate them, various kinds of security inks were used for printing on them with visible and hidden messages readable only with the aid of certain specified devices. Certain features such as watermarks, fluorescent fibers, barcodes etc were also used for providing added security. However, low strength security paper based labels could be easily removed one piece by the application of some heat energy. The other method was drops of commonly available solvents which eventually seeps into the adhesive layer, thereby loosening it, enabling the easy peel off of the labels without tearing it in the process. All these drawbacks necessitated the usage of label which would be tamper evident, destruct on exposure to some temperature, destructible with the aforementioned common liquids at the same time should be easily dispensable to allow easy application.

### SUMMARY OF THE INVENTION

Fraudsters are a constant source of grave concern to brand owners since they are involved in counterfeit, retail theft, parallel trading, brand piracy and product tampering. Billions of dollars are invested every year in building reputed brands and the importance for protecting the same against the ever present threat posed by counterfeiters and forgers is increasingly being recognized. Huge sum of money is invested in promoting and building a brand through extensive painstaking and complex marketing plans goes down the drains due to brand piracy. The recent breed of fraudsters are armed with sophisticated manufacturing and detecting equipments coupled with enhanced technical knowledge. Hence, in the light of these facts, the traditional security measures adopted by brand owners are of little help in the current scenario. The need of the hour is requirement of a foolproof solution to curb this menace.

As a positive step towards providing a solution to tackle this issue a method is developed of using a unique label to prevent this illegal activity. The present invention provides a “Guaranteed” solution to brand owners, various industries manufacturing their products, components, parts, assemblies and users of such products, instruments such as energy meters etc. to safeguard their brands by curbing pilferage and vandalism by counterfeiters and subsequently avoid massive revenue losses. This product offers a perfect balance of advanced effectiveness versus the cost for the same.

The present invention relates to the development and process of manufacturing of tamper evident, destructible with temperature and solvent sensitive (destructible) film having inherent property of exhibiting different coloured glow when exposed to UV light or optionally in-built silver/bronze or other sparkling colour. This film is print-receptive and can be easily printed with water based printing inks, invisible and other security inks available in the market.

This product is formulated by a combination of thermoplastic Acrylic polymer with a vinylic copolymer in ratios of 10:3 to 10:1 to form a paste made in regular aromatic solvent. This paste is coated on a double sided silicone resin coated substrate by conventional method of coating equipment to form a uniform film. The film formed thereafter has a thickness of 80 to 115 microns. The film has a special property of being strong enough to facilitate dispensing in its final (label) form at the same time strength low enough to prevent its removal from the substrate without tearing in the end product form. This film is coated with a special high tack adhesive by the transfer adhesive technique to convert the film into a self-adhesive which forms the basic raw material for the manufacturing of the said tamper evident, destructible with heat and solvent destructible labels. For achieving this the high tack adhesive is coated on double sided silicone resin coated substrate and laminated with the said film. The double sided silicone resin coated substrate utilized for the first step of film forming is removed by rewinding the stock on the mechanical rewinder to get the heat sensitive, solvent sensitive, tamper evident multi purpose security label (SURECOM).

The process of applying the high tack adhesive is by conventional method of coating equipment followed by using known drying-methods. This special high tack adhesive is capable of adhering to regular substrates as well as low energy surfaces like polypropylene polyethylene etc. The special high tack adhesive is manufactured by blending various materials comprising natural and/or synthetic rubbers, tackifying resins of natural/synthetic type, antioxidants followed by solvating with hydrocarbon/aromatic solvents to form a compound of proper consistency to facilitate coating and texture commensurate to the coating equipment. This special high tack adhesive of the present invention includes a tackifier which can be formed of hydrocarbon resins, rosin and rosin derivatives, polyterpenes, coumarone-indene resins, any compatible conventional tackifier or mixtures thereof along with mineral oils which are used as plastisizers.

The material used for the double sided silicone resin coated substrate could be papers like Glassine, Kraft or polymeric films like Polyester, Polyethylene, Polyvinyl Chloride etc or polycoated papers.

The stock formed herewith utilizing the aforesaid technique and ingredients is utilized as the basic raw material which goes into the making the novel labels. For achieving this, the heat sensitive, solvent sensitive, tamper evident multi purpose Security Label (SURECOM) is slit in to desired width.

The following is the schematic representation of the construction of the heat sensitive, solvent sensitive, tamper evident multi purpose Security Label (SURECOM):

FFFFFFFFFFFFFFF - - - Tamper evident, heat sensitive, solvent sensitive film.
AAAAAAAAAAAAAA - - - High tack adhesive
LLLLLLLLLLLLLLLL - - - Double sided Silicone resin coated substrate

1. A method of manufacturing “heat sensitive, solvent sensitive, tamper evident multi purpose security label (SURECOM)” comprises of the following:
(a) coating the formulated compound to constitute a film on a double sided silicone resin coated substrate;
(b) coating of high tack adhesive on double side silicone resin coated substrate and then by laminating the said film formed in the step 1 (a) to this adhesive to get the “heat sensitive, solvent sensitive, tamper evident multi purpose security label”, which when attempted to remove by use of heat and/or solvent from any adhered substrate indicates tampering as the polymeric film softens/disintegrates”
(c) The said formulated label is slitted in desired length and size;

2. “Heat sensitive, solvent sensitive, tamper evident multi purpose security label as claimed in claim 1, wherein the said formulated compound is made by combination of thermoplastic Acrylic polymer with a vinylic copolymer in ratios of 10:3 to 10:1 to form a paste in regular aromatic solvent by conventional method of coating equipment.

3. Heat sensitive, solvent sensitive, tamper evident multi purpose security label as claimed in claim 1, wherein the said high tack adhesive is made by blending (a) natural rubber and/or synthetic rubbers, (b) conventional tackifier such as hydrocarbon resins, polyterpenes or mixtures thereof, (c) antioxidants and (d) mineral oils, which are used as plastisizers; followed by solvating with hydrocarbon/aromatic solvents to form a compound of proper consistency to facilitate coating and texture commensurate to the coating equipment

4. Heat sensitive, solvent sensitive, tamper evident multi purpose security label as claimed in claim 1, wherein the said substrate could be papers like Glassine, Kraft or polymeric films like Polyester, Polyethylene, Polyvinyl Chloride or polycoated papers.

5. A method of manufacturing “heat sensitive, solvent sensitive, tamper evident multi purpose security label” as substantially described hereinabove.

6. A method of manufacturing “heat sensitive, solvent sensitive, tamper evident multi purpose security label” as claimed in claims 1, 2, 3 & 4 above by which “heat sensitive, solvent sensitive, tamper evident multi purpose security label” is obtained.
